(19) United States
(12) Patent Application Publication
(10) Pub. No.: US 2006/0104553 A1
(43) Pub. Date: May 18, 2006

(54) Radially adjustable linear bearing assembly

(75) Inventors: Carl Eric Faust, Cheshire, CT (US); Scott Crossman, Harwinton, CT (US); David Nguyen, Farmington, CT (US); John S. Hayward, Torrington, CT (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/271,070

(22) Filed: Nov. 10, 2005

Related U.S. Application Data
(60) Provisional application No. 60/627,481, filed on Nov. 12, 2004.
(60) Provisional application No. 60/714,666, filed on Sep. 7, 2005.

(51) Int. Cl. F16C 23/00; F16C 25/00; F16C 29/04

(52) U.S. Cl. 384/49; 384/519

(57) ABSTRACT

A linear bearing assembly comprising first and second cylindrical members. A first race member is positioned between the first and second cylindrical members. A plurality of rolling elements are positioned between the first cylindrical member and the second cylindrical member such that the first and second cylindrical members are linearly adjustable relative to one another. An adjustment mechanism is positioned between the plurality of rolling elements and one of the cylindrical members and is adjustable to remove any radial clearance between the rolling elements and the cylindrical members. The linear bearing assembly is well-suited for use with spindle applications, such as machine tools.

### CROSS-REFERENCE TO RELATED APPLICATIONS

This application claims the benefit of U.S. Provisional Patent Application Nos. 60/714,666, filed Sep. 7, 2005, and 60/627,481, filed Nov. 12, 2004. The entire contents of these applications are hereby incorporated by reference.

### BACKGROUND

This invention relates generally to linear roller bearings and more particularly to a radially adjustable linear roller bearing assembly.

Referring to FIG. 1, many spindle applications include an axially fixed radial bearing 102 or set of bearings located at one end of a rotating shaft or spindle 100 and an axial floating bearing 104 or set of bearings located at the other end. Typically axial motion is required at one end of a spindle 100 to compensate for axial thermal expansion in the direction of the shaft axis and/or to allow for sharing of a spring 110 preload between the fixed and floating bearings 102, 104.

High-speed grinding and milling spindles typically utilize a ball bearing cage assembly 104 to allow for axial motion of the floating bearing or set of bearings to both compensate for thermal growth and allow even sharing of the preload of the spring 110. In order to achieve smooth linear motion, the designer or builder must take radial thermal growth into consideration when selecting the radial internal clearance (RIC) for the ball bearing cage assembly 104. To achieve the selected RIC, the designer or builder must carefully choose a cage assembly with appropriate ball 106 diameters and cartridge 112 outside diameters and inside diameters. Often times, the desired RIC cannot be achieved due to limitations in measurement accuracy and to the unavailability of balls having the required diameters.

Typically, radial thermal growth of the ball bearing cage assembly exceeds the spindle housing. The precise thermal growth differential is not a known quantity and the designer or builder must estimate the value when selecting the ball diameters when assembling the ball bearing cage assembly with all components at room temperature. There is no method of adjusting the RIC of the floating ball bearing cage assembly cartridge that contains the floating bearing(s) when operating temperatures are achieved. If the amount of thermal growth is under estimated, the bearing cartridge RIC can become negative, and if the interference is too great it might hinder or prevent the floating cartridge from moving axially causing an axial bearing overload. If the amount of thermal growth is over estimated, the RIC can become excessive and allow misalignment and/or axial binding of the cartridge to occur.

### SUMMARY

In one embodiment, the present invention provides a linear bearing assembly comprising first and second cylindrical members. A first race member is positioned between the first and second cylindrical members. A plurality of rollers are positioned between the first race member and the first cylindrical member such that the first and second cylindrical members are linearly adjustable relative to one another. A radially adjustable mechanism is positioned between the race member and the second cylindrical member and configured to remove any radial clearance between the race member, the rollers and the first cylindrical member. The radially adjustable mechanism may provide automatic radial adjustment or manual radial adjustment.

In another embodiment, the present invention provides a linear bearing assembly comprising first and second cylindrical members. A plurality of rolling elements are positioned between the first cylindrical member and the second cylindrical member such that the first and second cylindrical members are linearly adjustable relative to one another. An adjustment mechanism is positioned between the plurality of rolling elements and one of the cylindrical members and is adjustable to remove any radial clearance between the rolling elements and the cylindrical members. The adjustment mechanism provides consistent and repeatable results.

In addition, the invention also provides a method of adjusting the RIC of a linear bearing assembly to achieve a desired stiffness of a spindle assembly. The method includes determining a target natural vibration frequency of the spindle assembly corresponding to a target stiffness of the spindle assembly and determining an actual natural vibration frequency of the spindle assembly corresponding to an actual stiffness of the spindle assembly. Then, the RIC of the linear bearing assembly can be adjusted to substantially match the actual stiffness with the target stiffness.

The inventive linear bearing assemblies can be used in spindle applications, such as machine tool applications (e.g., high-speed grinders).

### BRIEF DESCRIPTION OF THE DRAWINGS

FIG. 1 is a schematic view of a prior art spindle and bearing assembly.

FIG. 2 is a schematic view of a spindle and bearing assembly including a bearing assembly according to one embodiment of the present invention.

FIG. 3 is a side view of the coaxial, tubular linear roller bearing assembly of FIG. 2.

FIG. 4 is an exploded, perspective view of the coaxial, tubular linear roller bearing assembly of FIG. 3.

FIG. 5 is a partial cross-sectional view of the coaxial, tubular linear roller bearing assembly of FIG. 3, taken along the line 5--5 in FIG. 3.

FIG. 6 is a perspective view of a linear bearing cage with rollers of the tubular linear roller bearing assembly of FIG. 3.

FIG. 7 is a side view in cross-section of portions of a coaxial, tubular linear roller bearing assembly that is a second embodiment of the present invention.

FIG. 8 is a section view of a bearing assembly that is a third embodiment of the present invention.

FIG. 9 is a perspective view, partially broken away, of the bearing assembly of FIG. 8.

FIG. 10 is an exploded view of the bearing assembly of FIG. 8.

FIG. 11 is a front view of the bearing assembly of FIG. 8.

### DETAILED DESCRIPTION

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

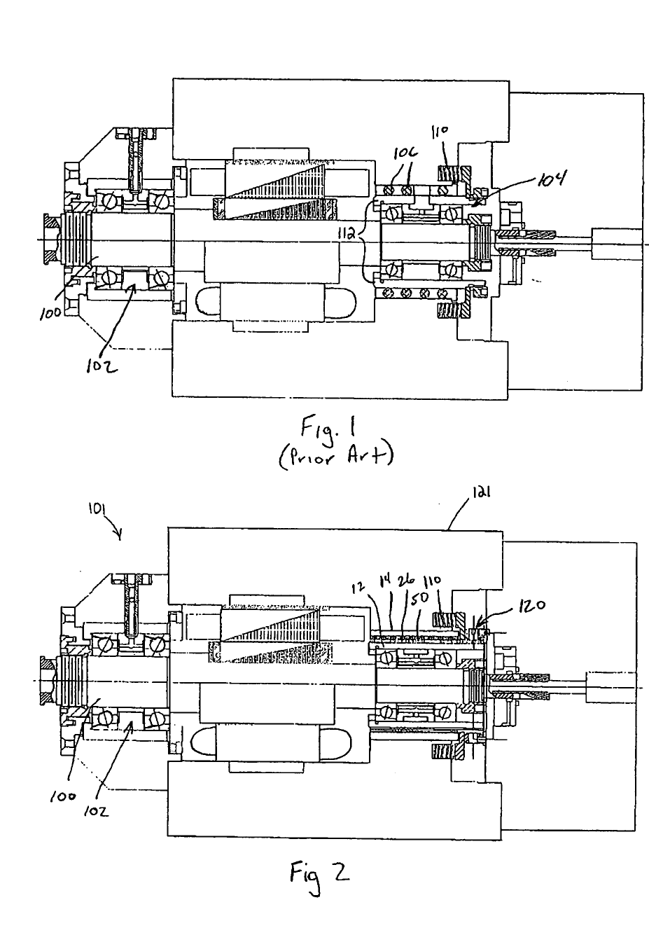

Referring to FIG. 2, a spindle assembly 101 incorporating a coaxial, tubular linear roller bearing assembly 120 of the present invention is shown. The spindle assembly 101 is similar to the prior art and includes a spindle or shaft 100 supported at one end by a fixed bearing assembly 102, and at the opposite end by a linear bearing assembly 120 of a first embodiment of the present invention. The spindle assembly 101 also includes a housing 121 configured to support the linear bearing assembly 120. While the present invention is shown in use with the illustrated spindle assembly 101, the linear bearing assembly 120 of the present invention can be utilized in various applications, including applications that do not have a second, fixed bearing assembly.

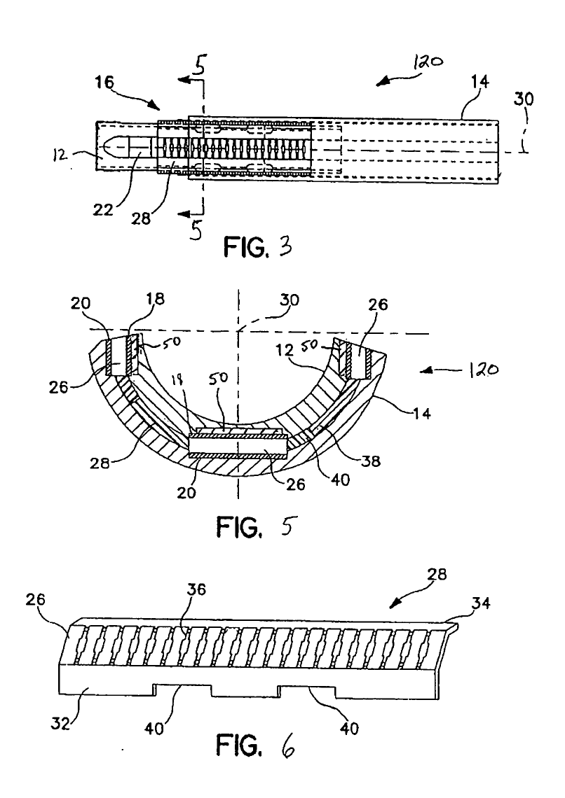

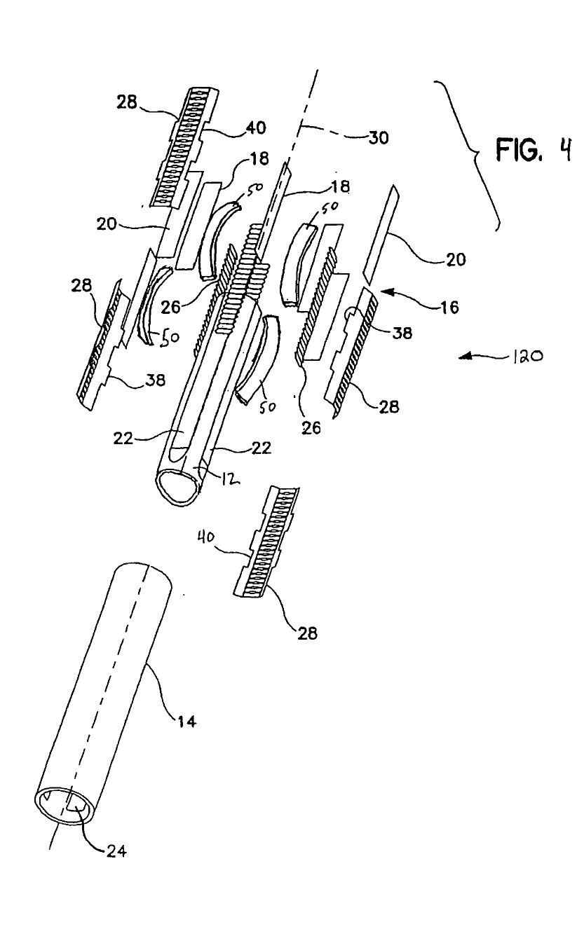

Referring now to the drawings, FIGS. 3 through 5 illustrate the coaxial, tubular linear roller bearing arrangement 120 having an inner tubular member 12 within a coaxial outer tubular member 14 and linear roller bearings 16 positioned therebetween for providing guided axial movement of the tubular members 12, 14 with respect to each other. While the tubular members 12, 14 are shown as independent tubes, they can also be integral cylindrical surfaces, for example, a bore in a housing or the external surface of a shaft.

In this embodiment of the present invention, linear roller bearings 16 include at least two pairs of elongated inner linear bearing races 18 and outer linear bearing races 20, positioned such that the inner linear bearing race 18 of each pair is radially aligned with and radially inward of the respective outer linear bearing race 20. Flat grooves 22 and 24 in the outer surface of inner tubular member 12 and in the bore of outer tubular member 14 receive the linear bearing races 18 and 20 to serve as backup members and prevent circumferential movement of the linear bearing races 18 and 20. Alternatively, if the tubular members 12 and 14 are made of suitable material, such as hardenable steel, for example, one of the raceways may be formed integrally in the tubular member 12 or 14, thereby eliminating the need for the separate linear bearing race.

To remove any RIC, each linear bearing 16 includes a radially adjustable or deformable biasing member 50 positioned between one of the races 18, 20 and the respective tubular member 12, 14. In the illustrated embodiment, each biasing member 50 is positioned between the inner race 18 and the inner tubular member 12, however, the biasing members 50 could alternatively be positioned between the outer race 20 and the outer tubular member 14. In the present embodiment, the biasing members 50 provide an automatic adjustment of the radial spacing between the races 18, 20 to ensure proper RIC for smooth operation of the linear bearing assembly 120. Furthermore, while the biasing members 50 are illustrated as leaf springs, other biasing means may also be utilized. For example, the biasing member 50 may consist of one or more coil springs or a block of resilient material, with the material chosen to be expandable and compressible to provide the desired RIC.

In the illustrated embodiment, the parallel rollers 26 are retained within a bearing cage 28 and are positioned between each pair of inner and outer linear bearing races 18 and 20 for rolling movement on the linear bearing races 18 and 20. The bearing cages 28 extend laterally, circumferentially with respect to axis 30 of the tubular members 12 and 14, and include side portions 32 and 34 that form a mechanical interlock with side portions of an adjacent bearing cage 28. The bearing cages 28 may have molded roller pockets 36 of conventional configuration for retaining the rollers 26. The mechanical interlock limits axial movement of one bearing cage 28 relative to an adjacent bearing cage 28.

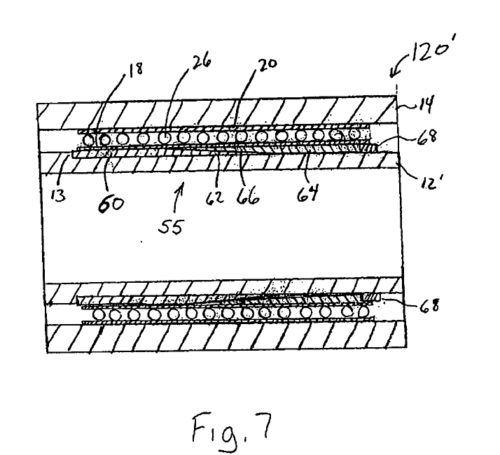

As illustrated in FIGS. 5 and 6, the mechanical interlock may be formed by projections 38 on side portions 34 of the bearing cages 28 engaging corresponding recesses 40 on side portions 32, although tabs, fingers, chevrons, curves and other projections of various configurations may be used. Preferably, the interlock allows a degree of circumferential movement and radial movement of adjacent bearing cages 28, while preventing relative axial movement of the bearing cages, to allow for dimensional tolerances of the coaxial tubular linear roller bearing arrangement. While the preferred bearing cages 28 are described, other cages may also be utilized or the rollers may be positioned without any cage.

Referring to FIG. 7, a coaxial, tubular linear roller bearing assembly 120′ that is a second embodiment of the present invention is shown. The linear bearing assembly 120′ is similar to the previous embodiment, but includes a mechanical adjustment assembly in place of the biasing members 50. The linear bearing assembly 120′ includes an inner tubular member 12′ and an outer tubular member 14. In the present embodiment, the inner tubular member 12′ is formed with an annular shoulder 13. Bearings 16 with inner and outer races 18 and 20 and rollers 26 are positioned between the inner and outer tubular members 12′ and 14. To achieve proper RIC, an adjustment mechanism 55 is positioned between each bearing 16 and one of the tubular members 12′, 14. In the illustrated embodiment, the adjustment mechanisms 55 are positioned between each inner race 18 and the inner tubular member 12′. The adjustment mechanism 55 includes a pair of opposed wedge members 60 and 64 with engaged, opposed ramped surfaces 62, 66. One of the wedge members 60 is axially retained by the shoulder 13. An adjustment screw 68 contacts the other wedge member 64 and controls the relative axial position of the two wedge members 60, 64. To expand the adjustment mechanism 55, the adjustment screw 68 is tightened such that wedge member 64 moves axially toward wedge member 60. The opposed ramps 62, 66 cause the adjustment mechanism 55 to expand radially, thereby removing any RIC. The adjustment screw 68 can be adjusted in the opposite direction to contract the adjustment mechanism 55. Other mechanical adjustment mechanisms are also contemplated.

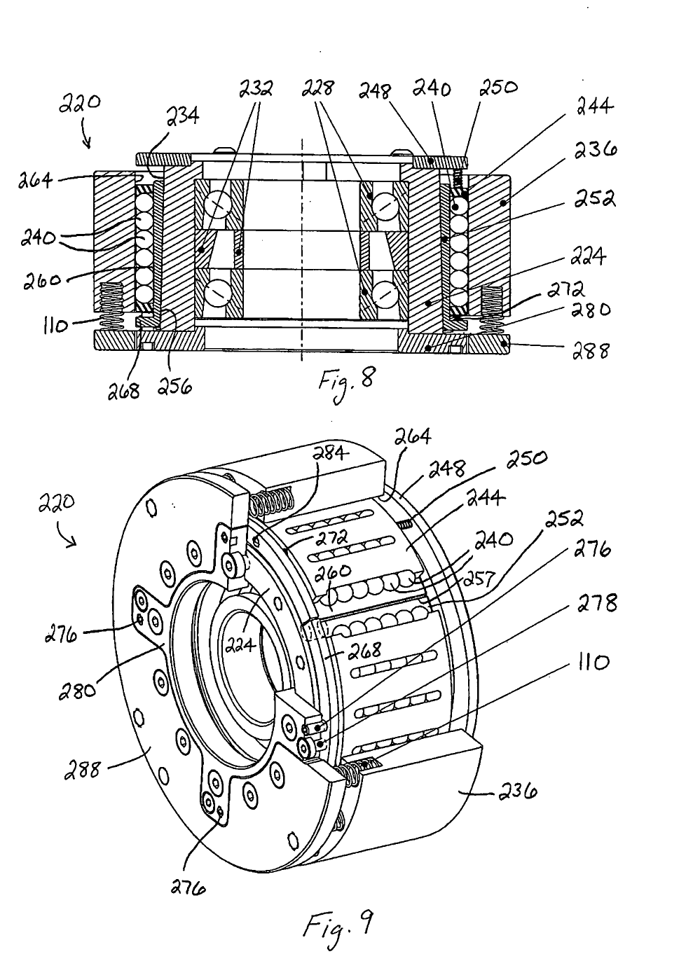

FIGS. 8-11 illustrate yet another embodiment of a linear bearing assembly 220 of the present invention. As shown in the figures, the linear bearing assembly 220 is designed as a unitized, or self-contained, insert to be used in a spindle assembly. The assembly 220 includes a cartridge 224 configured to support main spindle radial bearings 228 and a spacer 232. The spindle 100 is supported by the radial bearings 228. The illustrated cartridge 224 has a tapered outer surface 234 (see FIG. 8), the purpose of which will be discussed in more detail below.

The assembly 220 further includes an outer shell or housing 236 configured to be inserted (e.g., pressed) into the spindle housing 121 of the machine. Alternatively, the shell 236 can be an integral part of the spindle housing 121. To achieve the desired low-friction, axial movement between the cartridge 224 and the shell 236, a plurality of rolling elements 240 (e.g., balls) are supported between the cartridge 224 and the shell 236 by a retainer 244. It should be noted that in some embodiments the retainer 244 may not be used. An end cap 248 is coupled to the cartridge 224 and supports springs 250 that engage the retainer 244 to axially constrain the retainer 244 and the rolling elements 240. Of course, other methods for axially constraining the retainer 244 and the rolling elements 240 can be substituted.

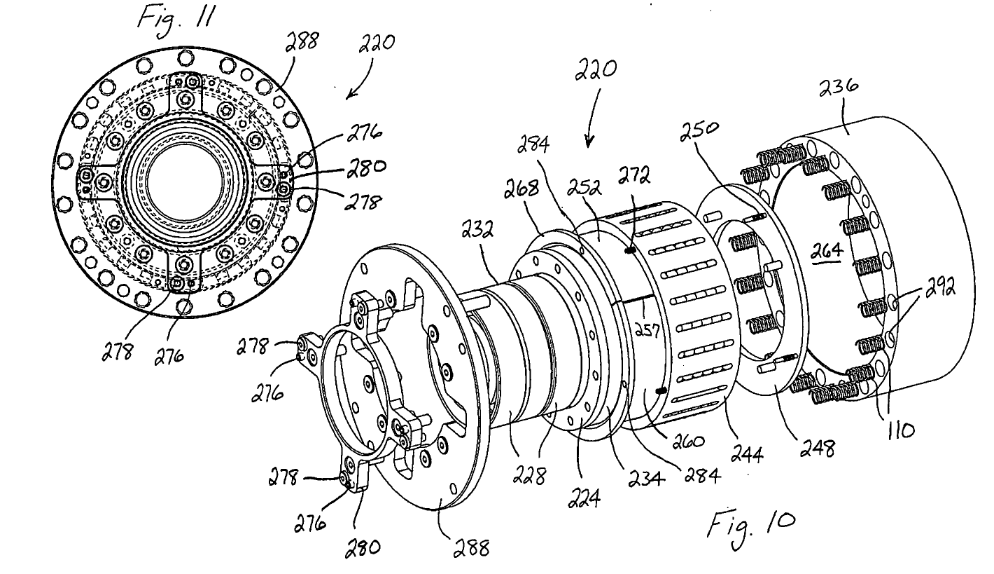

To achieve the desired RIC, an adjustment mechanism in the form of a sleeve 252 is positioned between the cartridge 224 and the shell 236 adjacent the rolling elements 240. As shown in FIG. 8, the sleeve 252 is shown as having a tapered inner bore 256 configured to receive and engage the tapered outer surface 234 of the cartridge 224. As shown in FIGS. 9 and 10, the sleeve 252 includes an axial slit 257 to reduce hoop stress and to permit axial and radial movement of the sleeve 252 relative to the cartridge 224. In other constructions the sleeve 252 can be a two-piece sleeve, but the two-piece sleeve may require additional alignment. In the illustrated embodiment, the straight outer surface 260 of the sleeve 252 acts as the inner bearing race supporting the rolling elements 240, while the inner surface or bore 264 of the shell 236 acts as the outer race. Alternatively, the sleeve 252 could be positioned so as to act as the outer bearing race while the outer surface of the cartridge could be configured to act as the inner bearing race. The sleeve 252 further includes a flange 268 that axially constrains the retainer 244 and the rolling elements 240 via springs 272 positioned between the flange 268 and the retainer 244. Of course, other methods for axially constraining the retainer 244 and the rolling elements 240 can be substituted.

To manually adjust the RIC of the assembly 220, the user adjusts one or more adjustment screws 276, 278 in an end cap 280 that is coupled to the cartridge 224. By adjusting the screws 276, 278, the user can move the sleeve 252 axially relative to the cartridge 224. Due to the tapered or ramped inner bore 256 of the sleeve 252 engaging the tapered or ramped outer surface 234 of the cartridge 224, the RIC can be adjusted as desired by moving the sleeve 252 axially relative to the cartridge 224. In the illustrated embodiment, the screws 276 are set screws with distal ends that engage and bear against the flange 268 of the sleeve 252 to control the axial proximity of the sleeve 252 relative to the end plate 280, and therefore relative to the cartridge 224. The screws 278 are cap screws that thread into apertures 284 in the flange 268 to draw the sleeve 252 tightly into engagement with the distal ends of the set screws 276, thereby locking the sleeve 252 into position. To adjust the position of the sleeve 252, the cap screws 278 are removed or loosened, and then the set screws 276 are adjusted to move the sleeve 252 axially. Once the sleeve 252 is positioned as desired, the cap screws 276 are tightened to lock the sleeve 252 into position as dictated by the distal ends of the set screws 276. This enables repeatable and consistent adjustment. It should be noted that other arrangements for adjusting the position of the sleeve 252 can also be used.

In addition, the user can adjust the RIC of the assembly 220 to achieve a desired preload and stiffness of the spindle assembly, which impacts the performance and quality achieved by the spindle assembly. An actual natural vibration frequency of the spindle assembly can be determined by striking the spindle assembly and measuring the vibrations. Using the actual natural vibration frequency, an actual stiffness of the spindle assembly can be determined. To achieve the target stiffness, a corresponding target natural vibration frequency can be determined. Then, the RIC of the assembly 220 can be manually adjusted, as described above, to substantially match the actual natural vibration frequency to the target natural vibration frequency to achieve the desired stiffness. It should be understood that the steps of determining the actual vibration frequency and the actual stiffness may need to be performed multiple times to substantial match the actual stiffness with the target stiffness.

The illustrated assembly 220 also includes a removable preload plate 288 that transmits the load from springs 110 seated in spring apertures 292 (see FIG. 10) positioned circumferentially around the shell 236 to the outer races of the main spindle radial bearings 228 to achieve the desired preloading.

The linear bearing assemblies 120, 120′, and 220 achieve linear motion while allowing compensation for thermal growth and allowing even sharing of the spring 110 preload. The linear bearing assemblies 120, 120′ will mount about the inner tubular member 12, 12′ that floats coaxially with respect to the outer tubular member 14 or housing 121, while the bearing assembly 220 is a unitized, or self-contained, insert. The present invention allows either manual or automatic adjustment of the RIC of the linear bearing assembly without the need for disassembly of the spindle or cage assembly. It can be provided as a stand-alone cartridge for use in existing spindles, or other applications, as a retrofit or incorporated in the design of a new spindle. With the linear bearing assemblies 120, 120′, 220 of the present invention, the spindle can be assembled with all components at room temperature without the need to estimate the operating temperatures of the various components and the RIC can be adjusted either manually or automatically when operating temperatures are achieved.

What is claimed is:

1. A bearing assembly comprising:
a linear bearing including,
a first generally cylindrical member;
a second generally cylindrical member; and
a plurality of rolling elements between the first and the second cylindrical members such that the first and the second cylindrical members are linearly moveable relative to each other;
an adjustment mechanism operable to adjust a clearance between the first and the second cylindrical members; and
a radial bearing coupled to one of the first and the second cylindrical members and configured to rotatably support a shaft.

2. The bearing assembly of claim 1, wherein the adjustment mechanism includes an axially movable member positioned between the first and the second cylindrical members.

3. The bearing assembly of claim 2, wherein the axially movable member is a sleeve.

4. The bearing assembly of claim 3, wherein the sleeve includes an axial slit.

5. The bearing assembly of claim 2, wherein the axially movable member is coupled to the one of the first and the second cylindrical members to define a raceway supporting the rolling elements.

6. The bearing assembly of claim 1, wherein the bearing assembly is a unitized assembly.

7. The bearing assembly of claim 1, wherein the adjustment mechanism is an automatic adjustment mechanism.

8. The bearing assembly of claim 7, wherein the automatic adjustment mechanism includes a spring.

9. The bearing assembly of claim 1, wherein the adjustment mechanism is a manual adjustment mechanism.

10. The bearing assembly of claim 9, wherein the manual adjustment mechanism includes an adjustment member that is adjusted via a screw.

11. The bearing assembly of claim 1, wherein the adjustment mechanism includes a tapered portion engaged with a tapered portion of one of the first and the second cylindrical members, and wherein the clearance between the first and the second cylindrical members is adjusted by moving the tapered portion of the adjustment mechanism relative to the tapered portion of the one of the first and the second cylindrical members.

12. A machine having a spindle assembly, the spindle assembly comprising:
a housing;
a shaft;
a bearing assembly supported by the housing, the bearing assembly including,
a linear bearing including,
a first generally cylindrical member;
a second generally cylindrical member; and
a plurality of rolling elements between the first and the second cylindrical members such that the first and the second cylindrical members are linearly moveable relative to each other;
an adjustment mechanism operable to adjust a clearance between the first and the second cylindrical members; and
a radial bearing coupled to one of the first and the second cylindrical members and configured to rotatably support the shaft.

13. The machine of claim 12, wherein the adjustment mechanism includes an axially movable adjustment member operable to adjust the clearance between the first and the second cylindrical members.

14. The machine of claim 13, wherein the axially movable adjustment member is a sleeve positioned between the first and the second cylindrical members.

15. The machine of claim 12, wherein the adjustment mechanism is coupled to one of the first and the second cylindrical members to define a raceway supporting the rolling elements of the linear bearing.

16. The machine of claim 12, wherein the adjustment mechanism includes a tapered portion engaged with a tapered portion of one of the first and the second cylindrical members, and wherein the clearance between the first and the second cylindrical members is adjusted by moving the tapered portion of the adjustment mechanism relative to the tapered portion of the one of the first and the second cylindrical members.

17. The machine of claim 12, wherein the bearing assembly includes a plate operable to apply a preload to the radial bearing configured to rotatably support the shaft.

18. The machine of claim 12, wherein the adjustment mechanism includes a radially deformable adjustment member operable to adjust the clearance between the first and the second cylindrical members.

19. A linear bearing assembly comprising:
a first generally cylindrical member;
a second generally cylindrical member;
a plurality of rolling elements between the first and the second members such that the first and the second members are linearly moveable relative to each other; and
an adjustment mechanism operable to adjust a clearance between the first and the second members and including a generally cylindrical sleeve disposed between the first and the second members.

20. The linear bearing assembly of claim 19, wherein the sleeve defines a raceway supporting the rolling elements.

21. The linear bearing assembly of claim 19, wherein the sleeve is axially movable to adjust a clearance between the first and the second members.

22. The linear bearing assembly of claim 19, wherein the sleeve includes an axial slit.

23. The linear bearing assembly of claim 19, wherein the sleeve includes a tapered portion engaged with a tapered portion of one of the first and the second members, and wherein the clearance between the first and the second members is adjusted by moving the tapered portion of the sleeve relative to the tapered portion of the one of the first and the second members.

24. A linear bearing assembly comprising:
a first generally cylindrical member;
a second generally cylindrical member;
a race member positioned between the first and the second cylindrical members;
a plurality of rolling elements positioned between the race member and the first cylindrical member such that the first and the second cylindrical members are linearly adjustable relative to one another; and
a radially adjustable mechanism positioned between the race member and the second cylindrical member and configured to remove any radial clearance between the race member, the rolling elements and the first cylindrical member.

25. The linear bearing assembly of claim 24, wherein the radially adjustable mechanism includes a spring.

26. The linear bearing assembly of claim 25, wherein the spring automatically deforms in a radial direction to remove any radial clearance between the race member, the rolling elements, and the first cylindrical member.
